(19) United States
(12) Patent Application Publication
(10) Pub. No.: US 2007/0282945 A1
(43) Pub. Date: Dec. 6, 2007

(54) Method and system of browsing using smart browsing cache

(75) Inventor: Man Mohan Singh Bisht, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (JP)

(21) Appl. No.: 11/807,816

(22) Filed: May 30, 2007

(30) Foreign Application Priority Data
May 30, 2006 (IN) 924/CHE/2006
May 25, 2007 (KR) 50738/2007

(51) Int. Cl. G06F 15/16

(52) U.S. Cl. 709/203

(57) ABSTRACT

Provided is a method and a system of browsing using a browser cache involving interacting with a browser and performing a cache associated action performed by a user using a mobile device. The method involves mapping an action performed by the user to a browser event and passing the browser event to the browser for processing and to perform the respective action. The method also involves a receiving user action as a browser event or a browser key event by the browser and processing the events; and displaying the browser cache page to the user by the mobile device.

### PRIORITY

This application claims priority under 35 U.S.C. §119(a) to applications entitled “METHOD AND SYSTEM OF BROWSING USING SMART BROWSER CACHE? filed in the Indian Intellectual Property Office on May 30, 2006 and the Korean Intellectual Property Office on May 25, 2007, and assigned India Serial No. 924/CHE/2006 and Korea Serial No. 2007-50738, respectively, the contents of which are hereby incorporated by reference.

### BACKGROUND OF THE INVENTION

1. Field of the Invention

The present invention in general relates to a browser cache concept, and more particularly, the present invention relates to a system and method for smart browser caching.

2. Description of the Related Art

The browser cache concept describes how a user accesses a browser cache page. For the browser cache page to be accessed by the user there is a need of a human interface between the user and a mobile device. The browser cache page concept includes following components—a user, an action, a browser, and mobile devices. A browser cache concept's mandatory requirement is the physical proximity between the user, the action, the browser, and the mobile devices. The browser cache concept includes storage of browser cache content in a folder and allowing the content in the folder to be used for a future access. The browser cache concept content includes graphic images, for example, buttons, banners, icons, advertisements, graphs, color bars, photographs, entire web pages, etc. The
a) Check the cache folder for requested content, and if the requested content is already present, the mobile device will not download the requested content again.
b) Check the cache folder for requested content, and if the requested content is not already present, the mobile device will download the requested content again.
   The browser cache concept loads content faster. The browser cache concept also allows the user to perform operations such as forward (Get a next cache page) and backward (Get a previous cache page) on the stored cache content in the folder. The concept is based on a human interface wherein the user interacts with the browser and gets access to a cache page.

A concept of how the browser cache concept works to allow a user to access a browser cache page will be described with reference to FIGS. 1A through 1E.

FIG. 1A represents steps to allow a user to perform actions to launch browser and home page displayed. User 10 uses a mobile device 13 and performs an action 11 (Press a launch browser soft key or press a launch browser hard key, which in-turn is mapped to a browser event and passed to a browser 12) on the mobile device 13 to launch the browser 12, in step 100. The action 11, performed by the user 10, is mapped to the browser event and passed to the browser 12 for processing and to perform a respective action, in step 105. The browser 12 receives the user action 11 as a browser event or a browser key event and processes those events and displays a home page, in step 110. The mobile device 13 makes communication possible between the user 10, the action 11, and the browser 12. Web content is displayed to the user 10 (Home page displayed) on the mobile device 13.

FIG. 1B represents steps to allow the user 10 to perform actions such as click mail and Yahoo!® (hereinafter “Yahoo!”) Mail page displayed. The user 10 uses the mobile device 13 and performs action 11 (Press a select browser soft key or press a select browser hard key, which in-turn is mapped to a browser key event and passed to the browser 12) on the mobile device 13 to click mail, in step 115. Action 11 performed by the user 10 is mapped to a browser event and passed to the browser 12 for processing and to perform a respective action, in step 120. Browser 12 receives the user action 11 as a browser event or a browser key event and processes those events and Yahoo! Mail page displayed, in step 125. The mobile device 13 makes communication possible between the user 10, the action 11, and the browser 12. Web content is displayed to the user 10 (Yahoo! Mail page displayed) on mobile device 13.

FIG. 1C represents steps to allow a user 10 to perform actions such as sign in to Yahoo! and inbox page displayed. The user 10 uses a mobile device 13 and performs action 11 (Press a browser soft key or press a browser hard key, which in-turn maps to a browser key event and passes to a browser) on the mobile device 13 to sign in to Yahoo!, in step 130. Action 11 performed by the user 10 is mapped to browser event and passed to the browser 12 for processing and to perform respective actions, in step 135. The browser 12 receives the user action 11 as a browser event or a browser key event and process those events and inbox page displayed, in step 140. The mobile device 13 makes communication possible between the user 10, the action 11, and the browser 12. Web content is displayed to the user 10 (Inbox page displayed) on the mobile device 13.

FIG. 1D represents steps to allow a user to perform action press back key and the previous cache page is displayed (Yahoo! Mail page displayed as per above example). The user 10 uses a mobile device 13 and performs action 11 on the mobile device 13 to press back key (pressing browser previous soft key, or pressing browser previous hard key, which is in-turn mapped to a browser key event and passed to the browser), in step 145. Action 11 performed by the user 10 is mapped to a browser event and passed to the browser 12 for processing and to perform respective action, in step 150. The browser 12 receives user action 11 as a browser event or a browser key event and processes those events, and a previous cache page is displayed Yahoo! Mail page displayed as per above example), in step 155. The mobile device 13 makes communication possible between the user 10, the action 11, and the browser 12. Web content is displayed to the user (Previous cache page is displayed (Yahoo! Mail page displayed as per our example)) on the mobile device 13.

FIG. 1E represents steps to allow a user 10 to perform actions press forward key and next cache page is displayed (where inbox page displayed as per above example). User 10 uses the mobile device 13 and performs action 11 (Press browser next soft key or press browser next hard key which in-turn is mapped to a browser key event and passed to the browser) on the mobile device 10 to press forward key, in step 160. Action 11, performed by the user 10, is mapped to a browser event and passed to the browser 12 for processing and to perform a respective action, in step 165. Browser 12 receives user action 11 as a browser event or a browser key event and processes those events, and a next cache page is displayed (where the inbox page displayed as per above example), in step 170. The mobile device 13 makes communication possible between the user 10, the action 11, and the browser 12. Web content is displayed to the user 10 (Next cache page is displayed (where the inbox page displayed as per our example)) on the mobile device 13.

Operation of the related art about how a browser cache concept works will now be explained as follows:

a) User
A user uses a mobile device and interacts with a browser and performs actions such as launch browser, click mail, sign in to Yahoo!, press back key, press forward key, etc.

b) Action
Actions performed by the user are mapped to a browser event or a browser key event and are passed to the browser for processing and to perform respective actions launch browser, click mail, and etc.

c) Browser
The browser receives user actions as browser events or browser key events and process those events, and based on the browser event home page displayed, Yahoo! Mail page displayed, inbox page is displayed, previous cache page is displayed, next cache page is displayed, etc . . . .

d) Mobile Device
The mobile device makes communication possible between the user, actions, and the browser. Web content is displayed to the user, such as home page displayed, Yahoo! Mail page displayed, inbox page is displayed, previous cache page is displayed, next cache page is displayed etc on the mobile device.

However, current browser cache page displays are based on some search criteria not supported. For example, a user cannot display selected cache pages based on some search criteria from a set of cache pages.

Current browser cache page forward traversal and back traversal methods are inefficient, as they require sequential traversal. For example, a user has ten cache pages, and currently on a cache page one, and wants to see web content of a cache page ten. In this case, the user presses a forward key ten times to see web content on the cache page ten. The user has ten cache pages, currently is on cache page ten, wants to see web content on cache page one, so in this case, the user presses a back key ten times to see content on cache page one.

Current browser cache page display traversal methods do not have a preview concept wherein all cache pages are displayed as thumbnails to the user, wherein the user can simply load specific cache pages directly, instead of loading all cache pages until the user reaches a specific cache page. Current browser cache page display traversal methods do not provide index based cache page display, for example, when a user wants to display a fourth cache page from a set of ten cache pages.

Current browser cache page display traversal methods do not provide a range base cache page display, for example, when a user wants to display the fourth to seventh cache pages from a set of ten cache pages.

### SUMMARY OF THE INVENTION

As stated above, there is a limit in effectively retrieving and displaying a desired cache page among various cache pages previously displayed.

Accordingly, the present invention provides a system and method for browsing to effectively display cache pages using a smart browser cache concept.

The present invention provides a system and method for browsing to search for cache pages wanted by a user, by using a smart browser cache concept framework and a third party vendor browser to support the smart browser cache concept.

The present invention is directed to a method of browsing using a browser cache, which includes of interacting with the browser and performing a cache associated action using a mobile device performed by a user, and mapping the action performed by user to a browser event and passing the action to the browser, performing a respective action for processing receiving the user action as a browser event or a browser key event by the browser and processing the events and displaying a browser cache page to the user by the mobile device.

A system for browsing using a browser cache according to the present invention includes a means for interacting with a browser and performing an associated cache; an action performed by a user using a mobile device; a means for mapping the action performed by the user to a browser event and passing the action to the browser for processing and to perform a respective action; a means for receiving the user action as a browser event or a browser key event by the browser and processing the events; and a means for displaying browser cache page to user by the mobile device.

A method of browsing using a browser cache according to the present invention includes the steps of interacting with a browser and performing a cache associated action using a mobile device by a user; mapping the action performed by the user to a browser event and passing the action to the browser for performing a respective action for processing; displaying web content using a smart browser cache concept framework when the browser receives the user action as a browser event or a browser key event; writing the web content to a cache display buffer and converting the written data into a cache thumbnail image; and displaying, by the mobile device, at least one cache thumbnail image, to the user.

### BRIEF DESCRIPTION OF THE DRAWINGS

The above and other objects, features and advantages of the present invention will be more apparent from the following detailed description taken in conjunction with the accompanying drawings, in which:

FIGS. 1A to 1E illustrate the browser cache concept according to prior art;

FIG. 2 is a flowchart illustrating a remote mobile device access and control method according to the present invention.

FIG. 3 is a flowchart illustrating another remote mobile device access and control method according to the present invention;

FIGS. 4 to 6 are flowcharts illustrating a smart browser cache concept according to the present invention; and

FIG. 7A to FIG. 7D illustrate a smart browser cache concept according to the present invention.

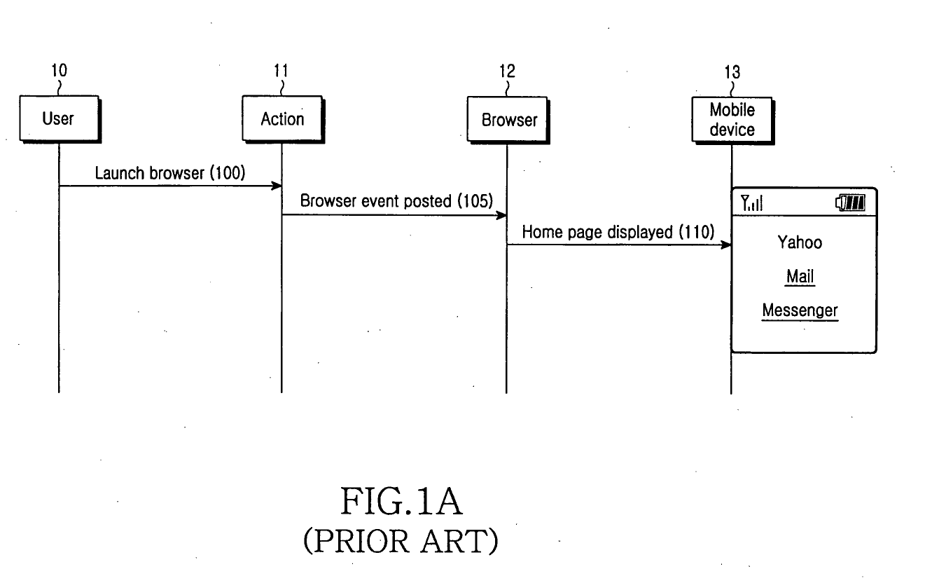

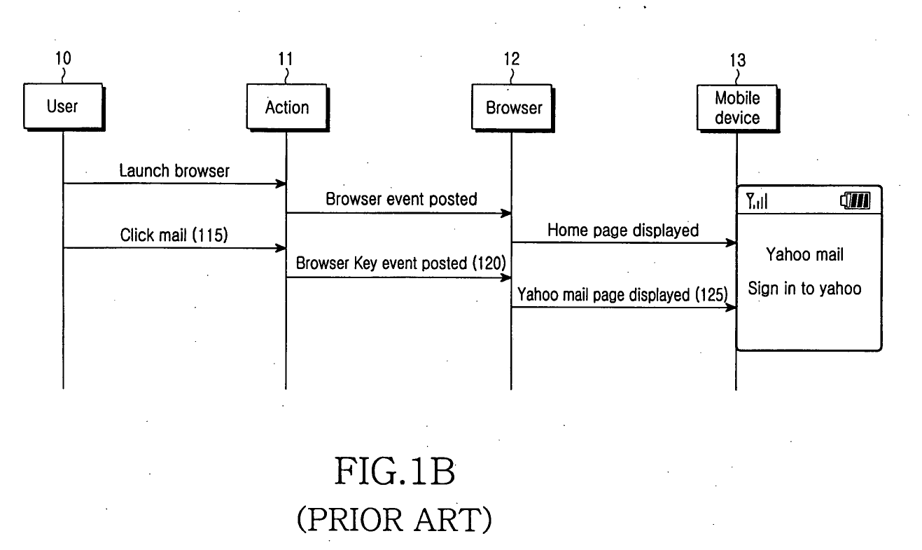

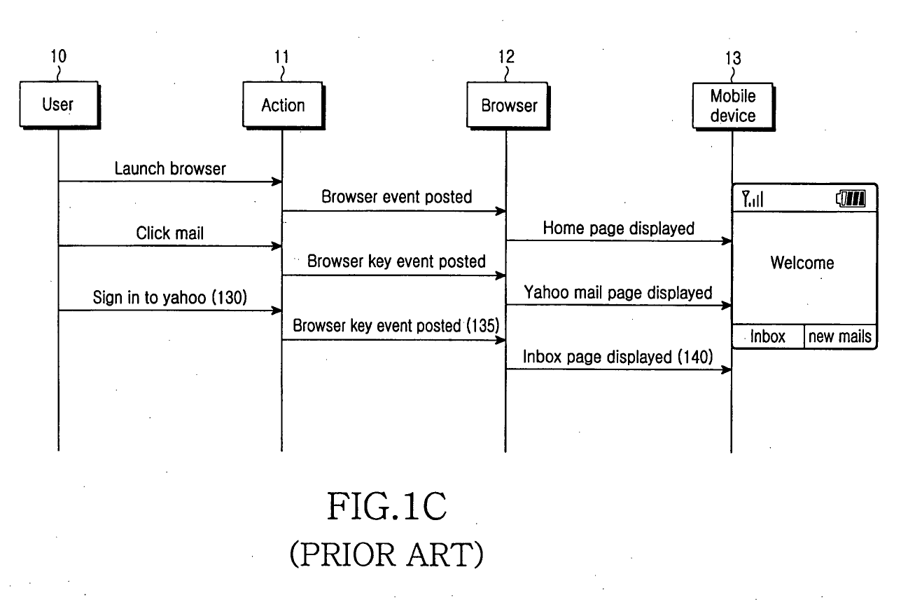

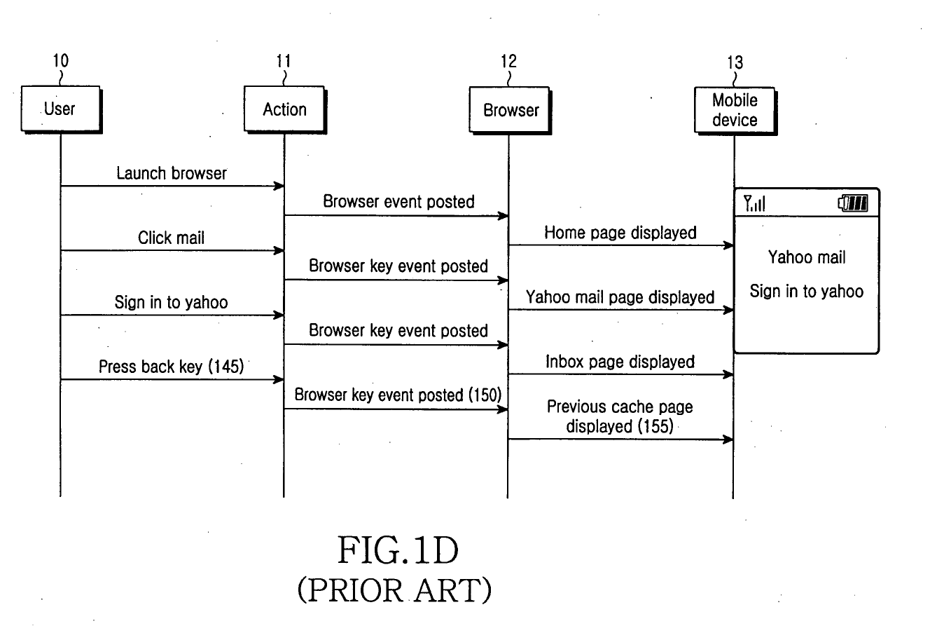

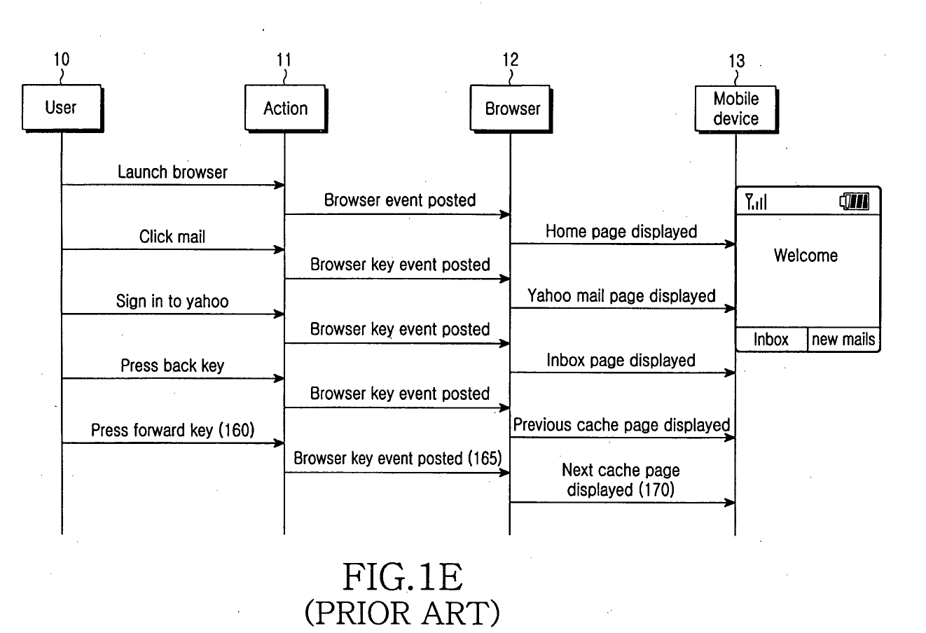

### DETAILED DESCRIPTION OF THE PREFERRED EMBODIMENT

The preferred embodiments of the present invention will now be explained with reference to the accompanying drawings. It should be understood however that the disclosed embodiments are merely exemplary of the invention, which may be embodied in various forms. The following description and drawings are not to be construed as limiting the invention and numerous specific details are described to provide a thorough understanding of the present invention, as the basis for the claims and as a basis for teaching one skilled in the art how to make and/or use the invention. However in certain instances, well-known or conventional details are not described in order not to unnecessarily obscure the present invention in detail.

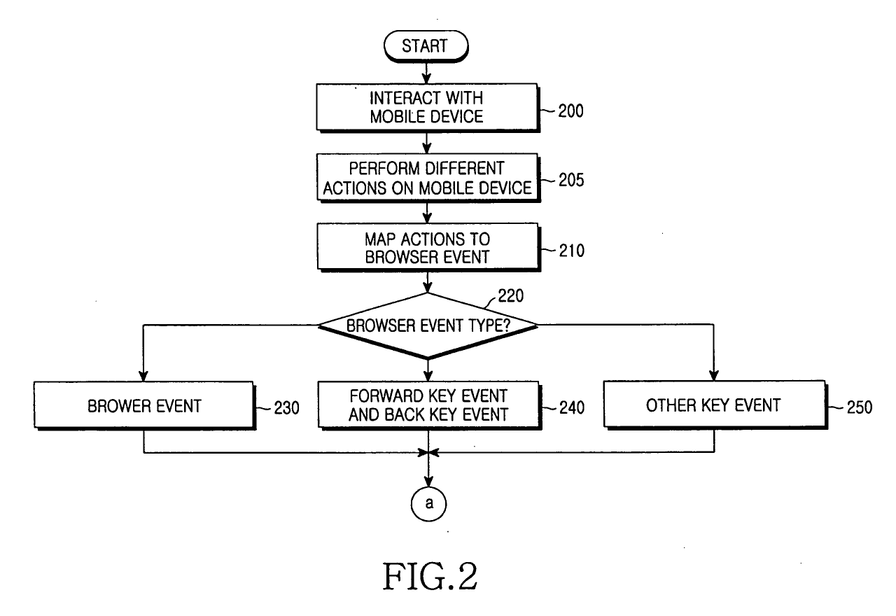

A smart browser cache concept according to the present invention removes limitations in present browser cache concepts. The smart browser cache concept according to the current invention consists of a user, an action, a browser and a mobile device. The browser consists of a third party vendor browser and a smart browser cache concept framework. A smart browser cache concept framework allows a browser cache page to be displayed based on a sequential traversal, allows the browser cache page to be displayed based on a search criteria, allows the browser cache page to be displayed based on a random traversal, allows the browser cache page to be displayed based on a preview concept, allows the browser cache page to be displayed based on an index concept, and allows the browser cache page to be displayed based on a range-based concept, etc. The smart browser cache concept is shown in FIGS. 2 to 6.

FIG. 2 represents a remote mobile device access and control method. The user interacts with his mobile device by means of a keypad interaction, a speech interaction, in step 200. The user interaction with the mobile device allows interaction with mobile device applications such as a browser, a telephone call, application, etc. The user performs different actions on the mobile device, such as start browser, display previous page, display next page, end browser, call, in step 205. Actions performed by the user are mapped to events by an event mapping layer, in step 210. In step 220, after determining browser event types, browser event types are passed to the browser as browser events, in step 230, or other key events, in step 250, to perform respective actions such as display home page, forward key event to display next cache page, back key event to display previous cache page, in step 240, etc.

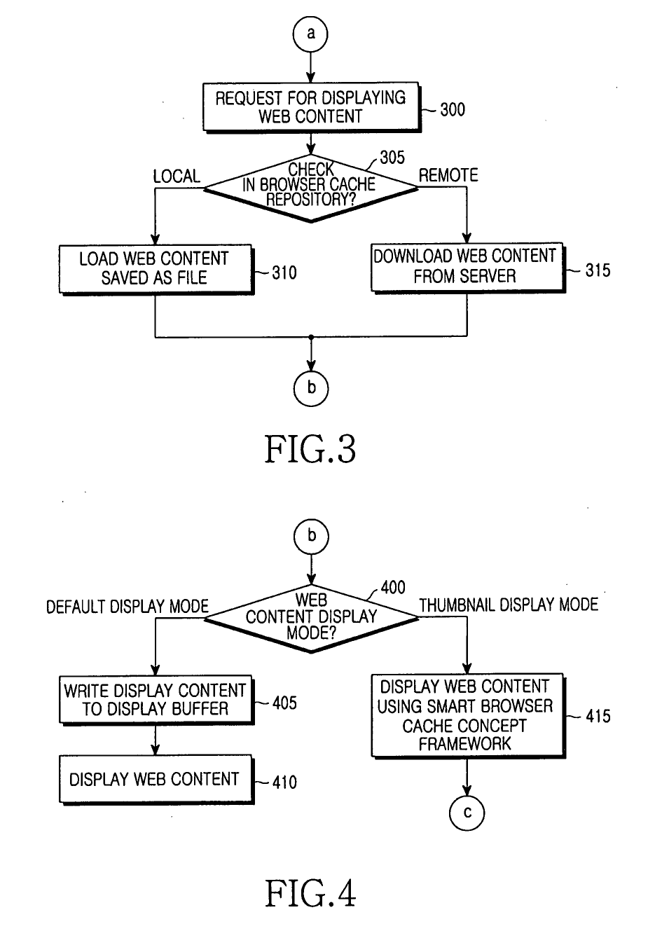

FIG. 3 represents another remote mobile device access and control method, following step 250. Based on the browser event types, a browser display, web content, etc., in step 300, if the browser is requested to display web content, the browser checks in a browser cache repository for the web content, in step 305, and based on a search result, the browser either loads the content from a local browser repository like a saved web content folder, in step 310, or remote downloads the content from a server, in step 315, based on browser cache settings, such as web content saved as a file in the local browser repository such as in a web content saved as file or web content not saved as a file the in local browser repository.

Following FIG. 3, FIGS. 4 to 6 represents a browsing procedure using the browser cache, in accordance with the present invention. First, in step 400, a web content mode is confirmed in order to display the web content. The smart browser cache concept will support two display modes, i.e., a default display mode (a Current browser content display mode) and a thumbnail display mode (a Smart browser cache concept content display mode). The default display mode of the browser writes the display content to a display buffer, in step 405, the display buffer is refreshed, and the web content is displayed to user, in step 410. During the thumbnail display mode of the browser, in step 415, the web content is displayed under a smart browser cache concept framework. The thumbnail display mode of browser allows communication between the third party browser and the smart browser cache concept framework. The smart browser cache concept framework allows display of web content in different display modes (an Auto display mode of the web content and a manual display mode of the web content), a browser cache content access mode (With running the browser and without running the browser), a browser history content access mode (With running the browser and without running the browser), a browser content display based on search criteria (a Sequential traversal, a random traversal, a search criteria, a preview criteria, a preview concept, index-based, range-based, etc.).

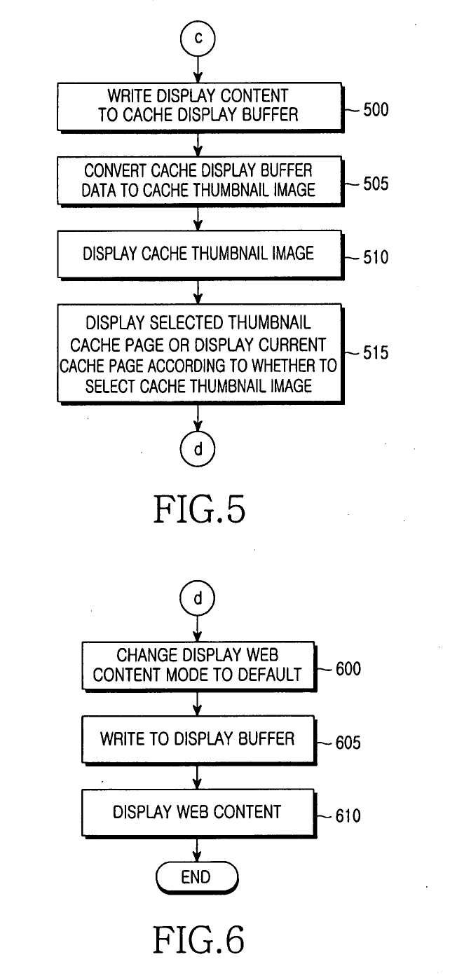

As shown in FIG. 5, the smart browser cache concept will write display content to the cache display buffer, in step 500, and convert cache display buffer data to cache thumbnail images, in step 505. Then display cache thumbnail images corresponding to presses of a back key or a forward key. The cache thumbnail images are displayed based on search criteria, such as index-based, range-based, etc., in step 510. The cache thumbnail images allow operations like thumbnail image selected (Thumbnail selected cache page is displayed) and thumbnail image not selected (Current cache page selected), in step 515.

As shown in FIG. 6, the smart browser cache concept framework will change the display web content mode to the default mode, in step 600. The smart browser cache concept framework will write to the display buffer, in step 605, and the web content is displayed to the user on the mobile device, in step 610.

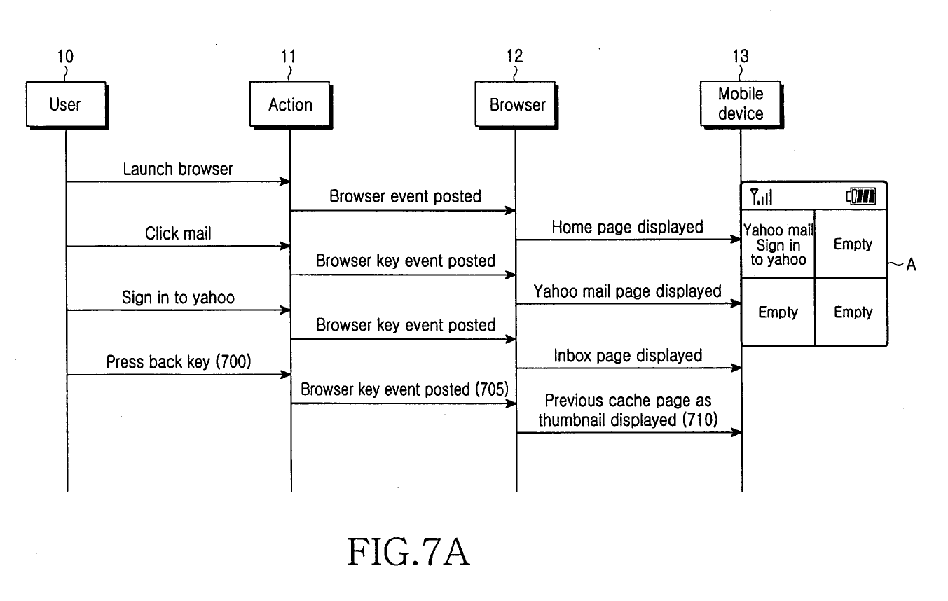

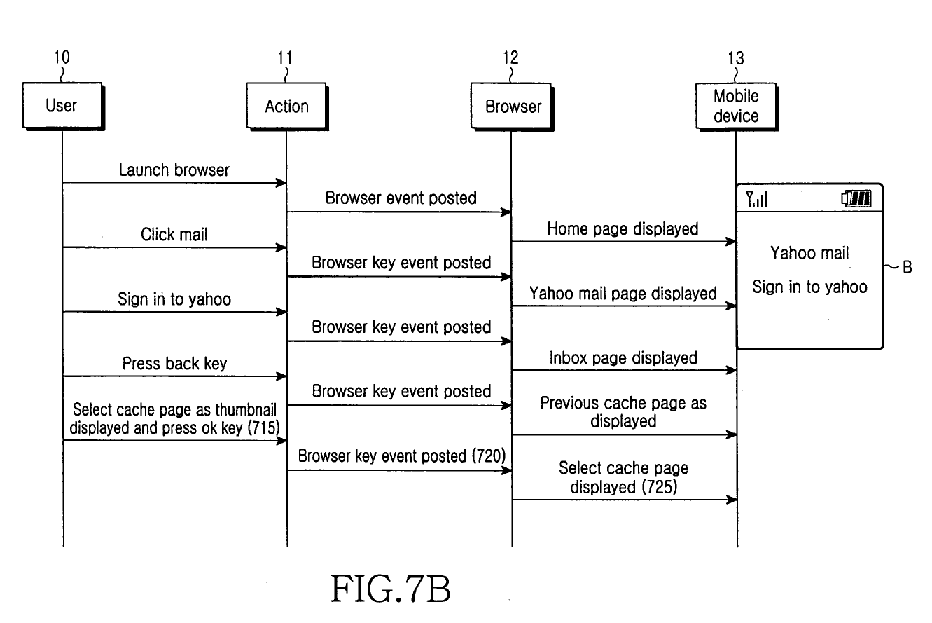

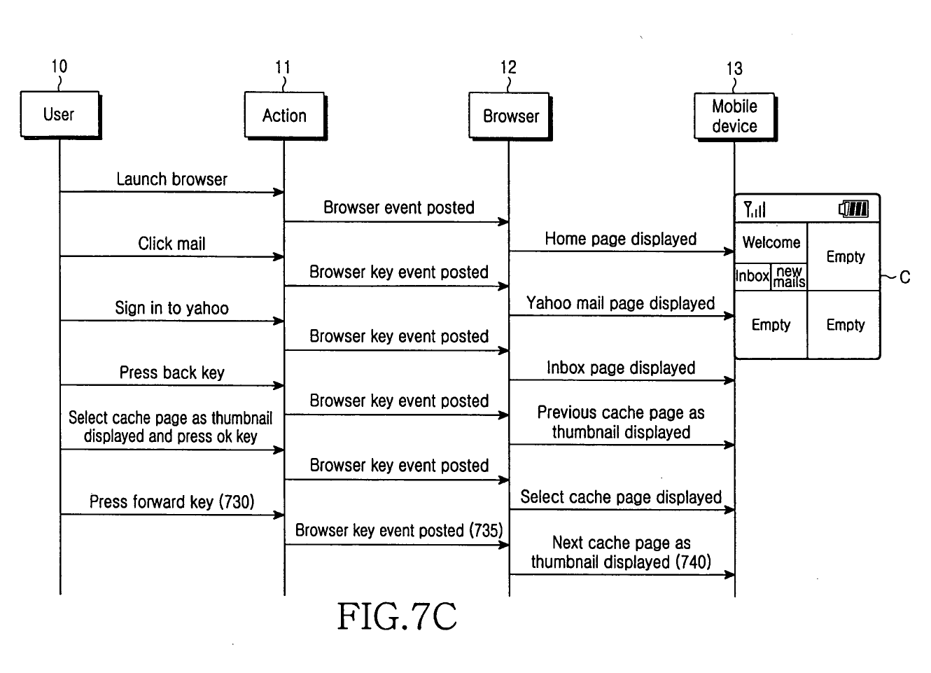

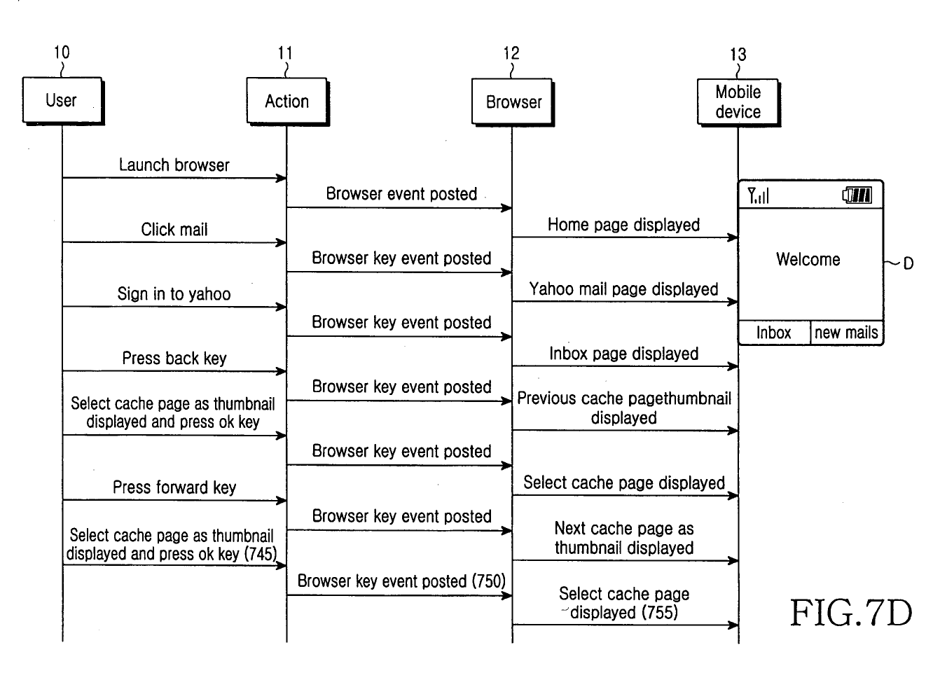

The method of the smart browser cache concept working to allow user access to the browser cache page, according to the present invention, will now be explained in reference to FIGS. 7A to 7D.

FIG. 7A represents steps for allowing a user 10 to access a press back key. The user 10 uses a mobile device 13, interacts with a browser 12, and performs actions like pressing a back key, in step 700. An action 11 performed by the user 10 is mapped to a browser event and passed to the browser 12 for processing and to perform respective actions, in step 705. The browser 12 receives the user action 11 as a browser event or a browser key event and process those events. The browser 12, based on the browser event, enables previous cache pages to be displayed as thumbnails, in step 710. The mobile device 13 enables communication between the user 10, the action 11, and the browser 12. Web content is displayed to the user 10 on the mobile device 13. On the mobile device 13, as indicated in a figure mark “A”, thumbnail images of previous page caches can be displayed in order to show a plurality of cache pages simultaneously.

FIG. 7B represents steps to allow a user 10 to access to select cache pages displayed as thumbnails and press an “K” key. The user 10 uses a mobile device 13, interacts with browser 12, and performs actions like selecting a cache page as a thumbnail to be displayed, in step 715, and pressing the “OK” key. Actions 11 performed by the user 10 are mapped to browser events and passed to the browser 12 for processing and to perform respective actions, in step 720. The browser 12 receives user actions 11 as browser events or browser key events and processes those events. The browser, based on the browser events, enables selected cache page to be displayed, in step 725. The mobile device 13 enables communication between the user 10, actions 11, and the browser 12. Web content is displayed to the user on the mobile device 13. A cache page selected as a figure mark “B” is displayed.

FIG. 7C represents steps to allow a user 10 to access a press forward key. The user 10 uses a mobile device 13, interacts with a browser 12, and performs actions like pressing a forward key, in step 730. Actions 11 performed by the user 10 are mapped to browser events and passed to the browser 12 for processing and to perform respective actions, in step 735. The browser 12 receives user actions 11 as browser events or browser key events and processes those events. The browser 12, based on browser events, enables a next cache page to be displayed as a thumbnail, in step 740. The mobile device 13 enables communication between the user 10, actions 11, and the browser 12. Web content is displayed to the user 10 on the mobile device 13. Such as in a figure mark “C”, thumbnail images are displayed after being able to show a plurality of cache pages simultaneously.

FIG. 7D represents steps to allow a user access to select a cache page to be displayed as a thumbnail and press an “OK” key.

User 10 use mobile device 13 and interact with browser 12 and perform action like selecting cache page as thumbnail to be displayed and pressing “OK” key, in step 745. Actions 11 performed by the user 10 are mapped to browser events and passed to the browser 12 for processing and to perform respective actions, in step 750. The browser 12 receives user actions 11 as browser events or browser key events and processes those events. The browser 12, based on browser events, enables a page cache, which is displayed for selection, in step 755. The mobile device 13 enables communication between the user 10, actions 11, and the browser 12. Web content is displayed to the user 10 on the mobile device 13. A cache page selected as a figure mark “D” is displayed.

The steps involved in the method of the present invention are as follows:

a) User
A user uses a mobile device and interacts with a browser and performs actions, such as launch browser, click mail, sign in to Yahoo!, press back key, select cache page as thumbnail displayed and press “OK” key, press forward key, and select cache page as thumbnail displayed and press “OK” key.

b) Action
Actions performed by the user are mapped to browser events and passed to the browser for processing and to perform respective action browser events (Launch browser) and browser key event (Click mail), etc.

c) Browser
The browser receives the user actions as browser events or browser key events and processes those events, such as home page displayed, Yahoo! Mail page displayed, inbox page is displayed, previous cache page as thumbnail displayed, select cache page displayed, next cache page as thumbnail displayed, select cache page displayed, etc.

d) Mobile Device
The mobile device enables communication between the user, the actions, and the browser. Web content is displayed to the user, such as home page displayed, Yahoo! Mail page displayed, inbox page is displayed, previous cache page as thumbnail displayed, select cache page displayed, next cache page as thumbnail displayed, select cache page displayed, etc. on the mobile device.

It will also be clear to those skilled in the art that other control methods and apparatuses can be derived from the combinations of the various methods and apparatuses of the present invention as taught by the description and the accompanying drawings and these shall also be considered within the scope of the present invention. Further, description of such combinations and variations is therefore omitted above. It should also be noted that the host for storing the applications includes but is not limited to a microchip, microprocessor, handheld communication device, computer, rendering device or a multi function device.

In regard to devices of the present invention, a smart browser cache concept obviates the limitations in present browser cache concept described above. The smart browser cache concept allows for browser cache page displays based on search criteria. The smart browser cache concept allows for browser cache page displays based on preview concepts, index-based, range-based, etc.

Although the present invention has been fully described in connection with the preferred embodiments thereof with reference to the accompanying drawings, it is to be noted that various changes and modifications are possible and are apparent to those skilled in the art. Such changes and modifications are to be understood as included within the scope of the present invention as defined by the appended claims unless they depart therefrom.

What is claimed is:

1. A method of browsing using a browser cache, the method comprising the steps of:
interacting with a browser and performing an action of a user using a mobile device, the action being associated with a cache; and
mapping the action performed by the user to a browser event, passing to the browser and performing a respective action, for receiving the user action as a browser event or a browser key event by the browser and processing the events, and for displaying a browser cache page to the user by the mobile device.

2. A method as claimed in claim 1 wherein a web content of the browser cache page is displayed in the browser in an auto display mode and a manual display mode.

3. A method as claimed in claim 1 wherein the browser cache page is accessed either with running the browser or without running the browser.

4. A method as claimed in claim 1 wherein a browser-history content of the browser cache page is accessed either with running the browser or without the running browser.

5. A method as claimed in claim 1 wherein the browser cache page display is based on a search criteria.

6. A method as claimed in claim 1 wherein the browser cache page display is based on sequential traversal search criteria.

7. A method as claimed in claim 1 wherein the browser cache page display is based on a random traversal search criteria.

8. A method as claimed in claim 1 wherein the browser cache page display is based on a preview concept.

9. A method as claimed in claim 1 wherein the browser cache page display is based on an index concept.

10. A method as claimed in claim 1 wherein the browser cache page display is range-based.

11. A method as claimed in claim 1, further comprising:
writing a display content of the browser cache page to a cache display buffer, using a smart browser cache concept; and converting the cache display buffer data to a cache thumbnail image.

12. A method as claimed in claim 11 wherein displaying the cache thumbnail image is based on search criteria.

13. A method as claimed in claim 11, further comprising displaying at least one cache thumbnail image; and when a cache thumbnail image is selected, displaying a cache page corresponding to the selected cache thumbnail image.

14. A method as claimed in claim 13 wherein a current cache page is selected when a cache thumbnail image is not selected.

15. A method as claimed in claim 13 wherein the cache thumbnail image is displayed using a smart browser cache concept framework, and wherein the smart browser cache concept framework changes a display web content mode to a default mode.

16. A method as claimed in claim 15 wherein the smart browser cache concept framework writes to a display buffer and displays web content to the user.

17. A system for browsing using a browser cache, the system comprising:
a means for interacting with a browser and performing an action associated with a cache, the action performed by a user using a mobile device;
a means for mapping the action performed by the user to a browser event and passing the action to the browser for processing and to perform a respective action;
a means for receiving the user action as browser events or browser key events by the browser and processing the events; and
a means for displaying a browser cache page to the user by the mobile device.

18. A method of browsing using a browser cache, the method comprising the steps of:
interacting with a browser and performing an action of a user using a mobile-device, the action being associated with a cache;
mapping the action performed by user to a browser event and passing the action to the browser to perform a respective action for processing;
displaying web content using a smart browser cache concept framework when the browser receives the user action as a browser event or a browser key event;
writing the web content to a cache display buffer and converting the written data into a thumbnail image; and
displaying, by the mobile device, at least one cache thumbnail image, to the user.
